(19) United States
(12) Patent Application Publication
(10) Pub. No.: US 2017/0127825 A1
(43) Pub. Date: May 11, 2017

(54) MODULAR STORAGE SYSTEM

(71) Applicant: Deborah L. Melnick, Sparks, MD (US)

(72) Inventor: Deborah L. Melnick, Sparks, MD (US)

(21) Appl. No.: 14/935,499

(22) Filed: Nov. 9, 2015

(51) Int. Cl. A47B 47/00; A47B 88/04; F16B 1/00; A47B 97/00; A47B 87/00; A47B 96/04; A47B 95/02

(52) U.S. Cl. CPC A47B 47/0091; A47B 47/0075; A47B 96/04; A47B 88/04; A47B 95/02; A47B 97/00; A47B 87/008; F16B 1/00; A47B 2095/024; A47B 2220/0077; F16B 2001/0035

(57) ABSTRACT

A modular storage system including at least one storage cube and at least one connector plate. The at least one storage cube has a body defined by a plurality of side walls and a base wall about an internal chamber. At least one of the side walls or the base wall includes a plurality of peg holes extending through the respective wall in a given pattern. The at least one connector plate has a planar body with opposed first and second surfaces. At least the first surface has a plurality of pegs extending therefrom in a pattern complementary to the given pattern such that the at least one connector plate is connected to the at least one storage cube by positioning at least a subset of the plurality of pegs extending from the first surface into respective peg holes on the at least one storage cube.

### FIELD OF THE INVENTION

This invention relates to a storage system. More particularly, the invention relates to a modular system of interconnectable cubes and accessories.

### BACKGROUND OF THE INVENTION

School and office supplies, such as notebooks, binders, pens, pencils, staplers, scissors, binding clips, loose leaf papers, rubber bands, correction tape, correction fluid, drawing guides, letter openers, highlighters, erasers, calculators and the like are often desired to be stored in a storage unit. Similar storage needs may be found in other areas as well, for example, garages and workshops for nails, screws, and the like, and in kitchens for spices, utensils and the like, and in bathrooms for makeup, applicator brushes, cotton swaps and the like. However, the storage needs for any individual user will vary from user to user and thus a single storage unit of fixed capacity may not meet the needs of different users. In addition, a user may often desire to modify the configuration of the storage unit. Accordingly, there is a need for a storage unit which can be assembled to meet the needs of individual users.

### SUMMARY OF THE INVENTION

In at least one embodiment, the present invention provides a modular storage system including at least one storage cube and at least one connector plate. The at least one storage cube has a body defined by a plurality of side walls and a base wall about an internal chamber. At least one of the side walls or the base wall includes a plurality of peg holes extending through the respective wall in a given pattern. The at least one connector plate has a planar body with opposed first and second surfaces. At least the first surface has a plurality of pegs extending therefrom in a pattern complementary to the given pattern such that the at least one connector plate is connected to the at least one storage cube by positioning at least a subset of the plurality of pegs extending from the first surface into respective peg holes on the at least one storage cube.

In at least one embodiment, the at least one connector plate has a plurality of pegs extending from the second surface in a pattern complementary to the given pattern such that the at least one connector plate is connected to a second of the at least one storage cubes by positioning at least a subset of the plurality of pegs extending from the second surface into respective peg holes on the second of the at least one storage cube.

In at least one embodiment, the second surface of the at least one connector plate is substantially flat and a plurality of magnets are embedded in the planar body adjacent the second surface.

In at least one embodiment, the second surface of the at least one connector plate is substantially flat and a plurality of magnets are embedded in at least a subset of the plurality of pegs extending from the first surface.

In at least one embodiment, the at least one storage cube includes at least two opposed grooves extending along respective inside surfaces of opposed side walls. The two opposed grooves are configured to receive and retain a divider panel which divides the internal chamber into at least two sub-chambers. In at least one embodiment, the divider panel has opposed tabs extending from an end thereof and the tabs are configured to be received in corresponding openings adjacent the grooves in the respective side walls of the at least one storage cube.

In at least one embodiment, the modular storage system further includes a drawer configured to be slidably positioned within the internal chamber of the at least one storage cube. The drawer may include a removable handle is secured thereto.

In at least one embodiment, the modular storage system further includes a divider cup configured to be received within the internal chamber of the at least one storage cubes. The divider cup includes a cup body including a plurality of side walls and a base wall about a cup internal chamber wherein a dividing wall extends between at least two of the cup side walls and divides the cup internal chamber into at least two cup sub-chambers. The cup side walls may have outwardly extending tabs configured to be received in corresponding openings in respective side walls of the at least one storage cube.

In at least one embodiment, the modular storage system further includes an accessory including a body with at least one peg extending therefrom and configured to be received and retained in one of the peg holes. The accessory is selected from the group consisting of a hook, a clip, a support shelf, a dry erase assembly, a mini picture frame, and a light fixture.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a modular storage system in accordance with an embodiment of the invention.

FIG. 2 is a perspective view of an exemplary square cube of the modular storage system illustrated in FIG. 1.

FIG. 3 is a perspective view of an exemplary rectangular cube of the modular storage system illustrated in FIG. 1.

FIG. 4 is a perspective view of an exemplary magazine cube of the modular storage system illustrated in FIG. 1.

FIG. 5 is a perspective view of an exemplary connector plate in accordance with an embodiment of the invention.

FIG. 6 is a perspective view of another exemplary connector plate in accordance with an embodiment of the invention.

FIG. 7 is a perspective view of an exemplary magnetic connector plate in accordance with an embodiment of the invention.

FIG. 8 is a perspective view of an exemplary support mat in accordance with an embodiment of the invention.

FIGS. 9 and 10 are perspective views of an exemplary divider panel in accordance with an embodiment of the invention in horizontal and vertical orientations, respectively.

FIG. 11 is a perspective view of another exemplary divider panel in accordance with an embodiment of the invention.

FIGS. 12 and 14 are perspective views of exemplary horizontal connector panels and FIG. 13 is a perspective view of an exemplary vertical connector panel.

FIG. 15 is a perspective view of another exemplary divider panel formed utilizing interconnected vertical and horizontal connector panels.

FIG. 16 is a perspective view of another exemplary divider panel in accordance with an embodiment of the invention.

FIG. 17 is a perspective view of an exemplary divider cup in accordance with an embodiment of the invention.

FIG. 18 is a perspective view of an exemplary drawer in accordance with an embodiment of the invention.

FIG. 19 is a side elevation view of a handle of the drawer of FIG. 18.

FIG. 20 is a perspective view of another drawer in accordance with an embodiment of the invention.

FIGS. 21 and 22 are a perspective view and side view, respectively, of an exemplary hook in accordance with an embodiment of the invention.

FIGS. 23 and 24 are a perspective view and side view, respectively, of an exemplary hook in accordance with an embodiment of the invention.

FIG. 25 is a perspective view of an exemplary clip in accordance with an embodiment of the invention.

FIG. 26 is a front perspective view of an exemplary support shelf in accordance with an embodiment of the invention.

FIG. 27 is a rear perspective view of the support shelf of FIG. 26.

FIG. 28 is a perspective view of an exemplary dry erase assembly in accordance with an embodiment of the invention in a closed position.

FIG. 29 is a perspective view of the dry erase assembly of FIG. 28 in an open position.

FIG. 30 is a front perspective view of an exemplary picture frame in accordance with an embodiment of the invention.

FIG. 31 is a rear perspective view of the picture frame of FIG. 30.

FIG. 32 is a front elevation view of an exemplary mini picture frame in accordance with an embodiment of the invention.

FIG. 33 is a rear elevation view of the mini picture frame of FIG. 32.

FIG. 34 is a perspective view, partially exploded of a picture cube in accordance with an embodiment of the invention.

FIG. 35 is a perspective view of an exemplary bulb light fixture in accordance with an embodiment of the invention.

FIG. 36 is a perspective view of an exemplary ornamental light fixture in accordance with an embodiment of the invention.

FIG. 37 is a perspective view of another exemplary ornamental light fixture in accordance with an embodiment of the invention.

FIG. 38 is a perspective view of an exemplary single peg light fixture in accordance with an embodiment of the invention.

FIG. 39 is a front elevation view of another exemplary single peg light fixture in accordance with an embodiment of the invention.

FIG. 40 is a perspective view of an exemplary clock accessory in accordance with an embodiment of the invention.

FIG. 41 is a top plan view of the clock accessory of FIG. 40.

FIG. 42 is a front perspective view of an exemplary ear bud support assembly in accordance with an embodiment of the invention.

FIG. 43 is a rear perspective view of the ear bud support assembly of FIG. 42.

FIG. 44 is a top plan view of an exemplary support pad in accordance with an embodiment of the invention.

FIG. 45 is a side elevation view of the support pad of FIG. 44.

FIGS. 46-48 are perspective views illustrating an exemplary phone mount assembly in accordance with an embodiment of the invention.

### DETAILED DESCRIPTION OF THE INVENTION

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

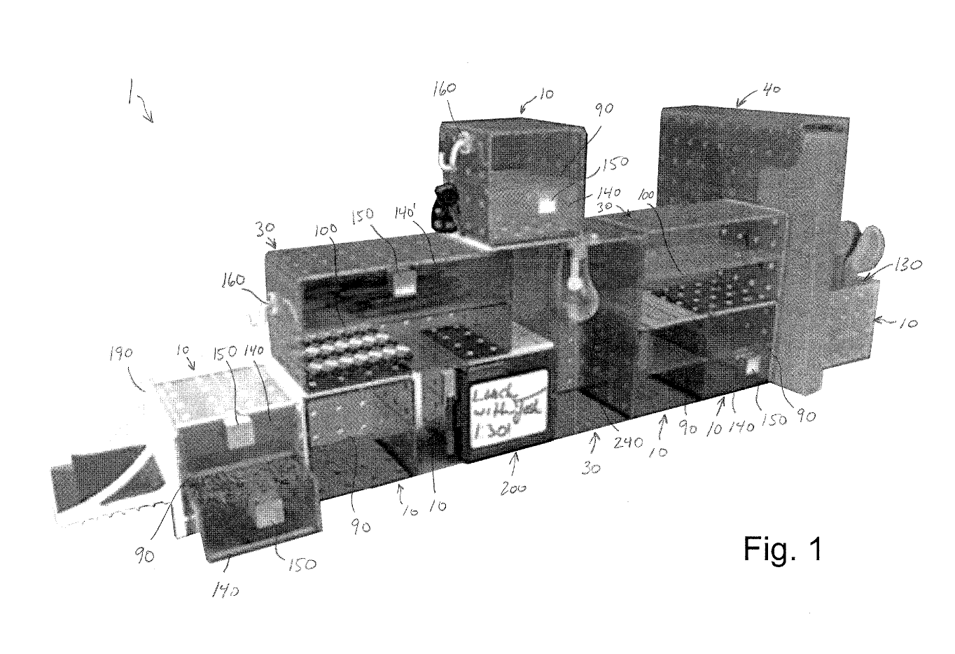

Referring to FIG. 1, a modular storage system 1 in accordance with an exemplary embodiment of the invention is illustrated. The storage system 1 includes a plurality of interconnected cubes 10, 30 and 40 of various sizes and configurations. The storage system 1 may include various accessories positioned within or supported by the cubes 10, 30, 40. In the illustrated embodiment, the accessories include divider panels 90, 100; a divider cup 130, drawers 140, 140′ with handles 150; hooks 160; a support shelf 190; a dry erase assembly 200 and a light fixture 240. A user may pick any configuration of cubes and accessories, including more or fewer than those illustrated in FIG. 1.

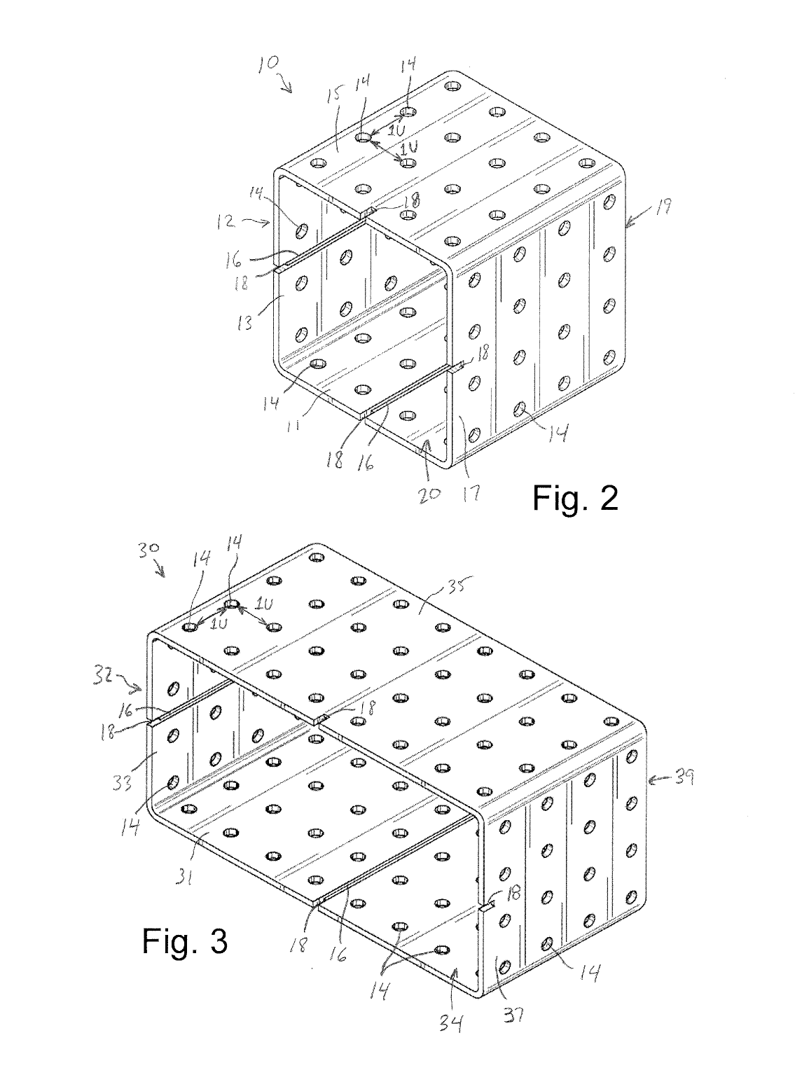

Referring to FIGS. 2-4, the exemplary cubes 10, 30 and 40 will be described. The cube 10 illustrated in FIG. 2 has a square configuration with a body 12 defined by a plurality of side walls 11, 13, 15, 17 and a base wall 19 with an open internal chamber 20. The side walls 11, 13, 15, 17 have the same length and width dimensions to form the square configuration. Each of the side walls 11, 13, 15, 17 and the base wall 19 has a series of peg holes 14 to facilitate interconnection of two cubes 10, 30, 40 or connection of the accessories to the cubes 10, 30, 40. In the illustrated embodiment, on each wall, the peg holes 14 are positioned in a grid pattern with equal spacing (1 Unit, e.g. 1 inch or 2 cm) between adjacent peg holes 14. The invention is not limited to the illustrated spacing or pattern and other configurations may be utilized. Additionally, while each of the peg holes 14 is illustrated as a through hole, it is contemplated that some of the holes may be formed as blind holes that do not extend completely through the wall.

In addition to the peg holes 14, each of the side walls 11, 13, 15, 17 has a groove 16 along its inside surface with the groove 16 extending substantially perpendicular to the base wall 19. The grooves 16 are configured to receive divider panels, as will be described hereinafter, to divide the chamber 20 of the cube 10. The groove 16 of each side wall 11, 13, 15, 17 is preferably located at the midpoint of the wall to divide the chamber 20 into equal volumes. The end of each groove 16 opposite the base wall 19 preferably defines an opening 18 which receives tab portions of the accessories as will be described hereinafter.

Referring to FIG. 3, the cube 30 is similar to cube 10 but has a rectangular configuration. The cube 30 has a body 32 defined by a plurality of side walls 31, 33, 35, 37 and a base wall 39 with an open internal chamber 34. The side walls 33 and 37 have the same length and width dimensions as the side walls 11-17 of cube 10, however, the side walls 31 and 35 have a longer length while having the same width to form the rectangular configuration. In the illustrated embodiment, the side walls 31 and 35 have a length that is twice that of the side walls 33 and 37, however, other sizes and configurations are possible. It is noted that the cube 30 may be positioned such that the longer length extends horizontally or vertically.

As with the cube 10, each of the side walls 31, 33, 35, 37 and the base wall 39 has a series of peg holes 14 in a similar grid pattern with equal spacing between adjacent peg holes 14. The invention is not limited to the illustrated spacing or pattern and other configurations may be utilized. Additionally, while each of the peg holes 14 is illustrated as a through hole, it is contemplated that some of the holes may be formed as blind holes that do not extend completely through the wall. Additionally, each of the side walls 31, 33, 35, 37 has a groove 16 along its inside surface with the groove 16 extending substantially perpendicular to the base wall 39. Again, the groove 16 of each side wall 31, 33, 35, 37 is preferably located at the midpoint of the wall to divide the chamber 34 into equal volumes. The end of each groove 16 opposite the base wall 39 preferably defines an opening 18 which receives tab portions of the accessories as will be described hereinafter.

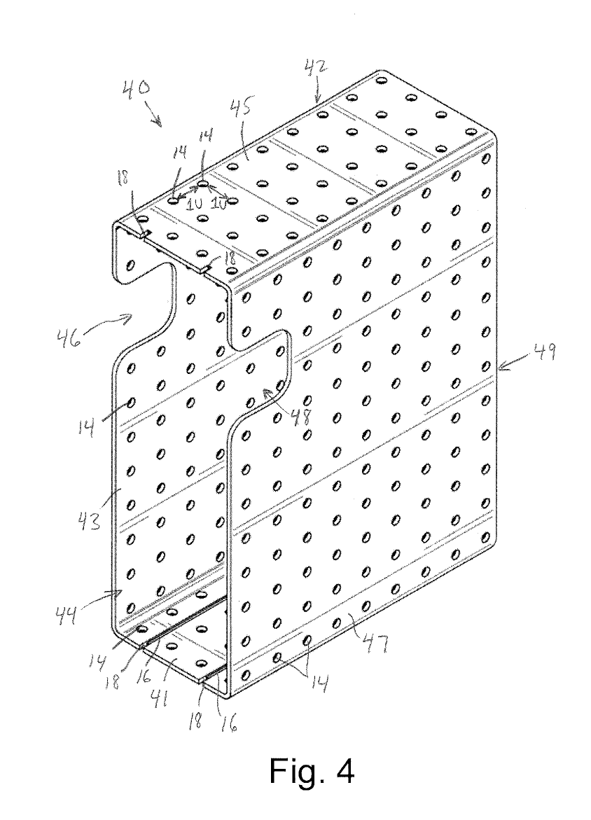

Referring to FIG. 4, the cube 40 is similar to cube 10 but has a rectangular configuration. The cube 40 has a body 42 defined by a plurality of side walls 41, 43, 45, 47 and a base wall 49 with an open internal chamber 44. In the illustrated embodiment, the side walls 41 and 45 have a length which is less than the length of the side walls 43 and 47 to form the rectangular configuration. In the illustrated embodiment, the side walls 43 and 47 have a length that is three times that of the side walls 41 and 45, however, other sizes and configurations are possible. Additionally, the side walls 43 and 47 have respective notches 46, 48 therein which make access to papers, magazines or the like stored within the chamber 44 more easily accessible.

As with the cube 10, each of the side walls 41, 43, 45, 47 and the base wall 49 has a series of peg holes 14 in a similar grid pattern with equal spacing between adjacent peg holes 14. The invention is not limited to the illustrated spacing or pattern and other configurations may be utilized. Additionally, while each of the peg holes 14 is illustrated as a through hole, it is contemplated that some of the holes may be formed as blind holes that do not extend completely through the wall. Additionally, the side walls 41 and 47 each have a pair of grooves 16 along its inside surface with the grooves 16 extending substantially perpendicular to the base wall 49. The grooves 16 facilitate divider panels which divide the chamber 44 into long sub-chambers. Such a configuration may be advantageous for storing magazines, paper or the like. The end of each groove 16 opposite the base wall 49 preferably defines an opening 18 which receives tab portions of the accessories as will be described hereinafter.

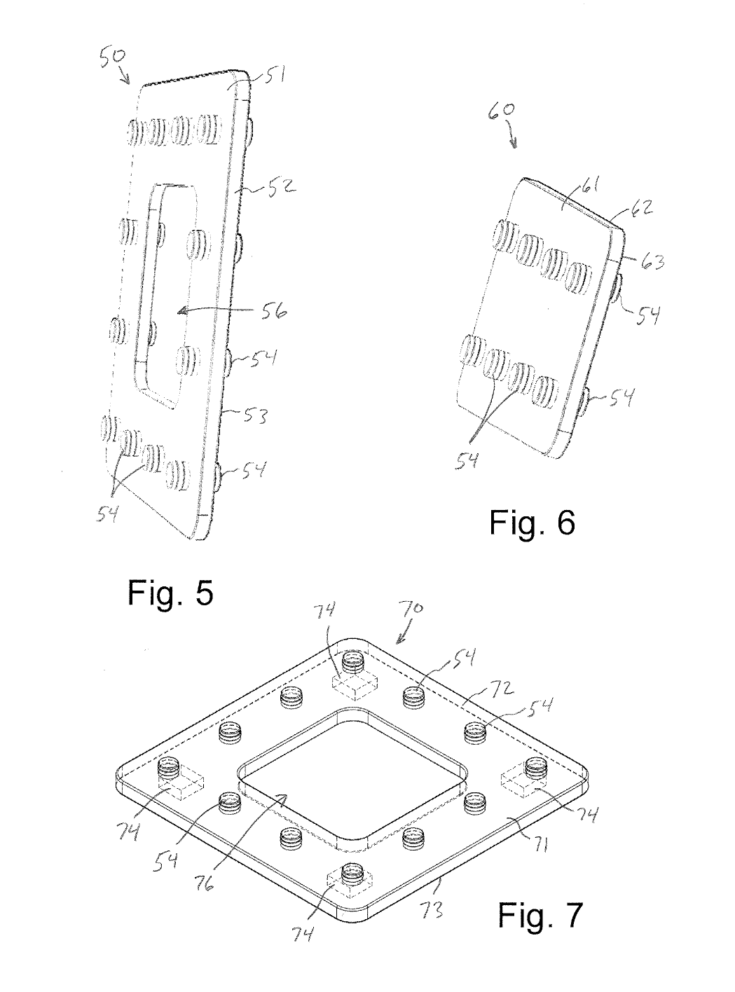

Referring to FIGS. 5 and 6, exemplary connector plates 50 and 60 for interconnecting adjacent cubes 10, 30, 40 will be described. The connector plate 50 includes a square body 52 with opposed surfaces 51 and 53. A series of pegs 54 extend from each surface 51, 53, preferably co-axial with a respective peg 54 on the opposite surface. The pegs 54 are positioned in a pattern which complements the pattern of the peg holes 14. In the illustrated embodiment, the pegs 54 are in a grid pattern with equal spacing (1U) between adjacent pegs 54. The pegs 54 are sized to be received in the peg holes 14, preferably with a snap, pressure or friction fit. The body 52 includes a through opening 56 which reduces material for the plate, with the perimeter pegs 54 providing sufficient points of interconnection between the cubes 10, 30, 40. The connector plate 60 is similar, except for the body 62 has a rectangular configuration with two rows of pegs 54 on each surface 61, 63 of the body 62. Again, the pegs 54 are positioned in a pattern which complements the pattern of the peg holes 14.

Referring to FIG. 7, an exemplary magnetic connector plate 70 is illustrated. The magnetic connector plate 70 is similar to the plate 50 and includes a square body 72 with opposed surfaces 71 and 73 and a through opening 76. With the magnetic connector plate 70, pegs 54 extend only from one of the surfaces 71, with the other surface 73 substantially flat. A plurality of magnets 74 are embedded in the body 72 and extend proximate the surface 73. With this configuration, the pegs 54 engage a cube 10, 30, 40 and the magnets 74 facilitate mounting of the cube 10, 30, 40 to a metallic surface, for example, a locker or desk. While the magnets 74 are illustrated in the body 72, it is contemplated that magnets may be provide in place or in addition to within the pegs 54.

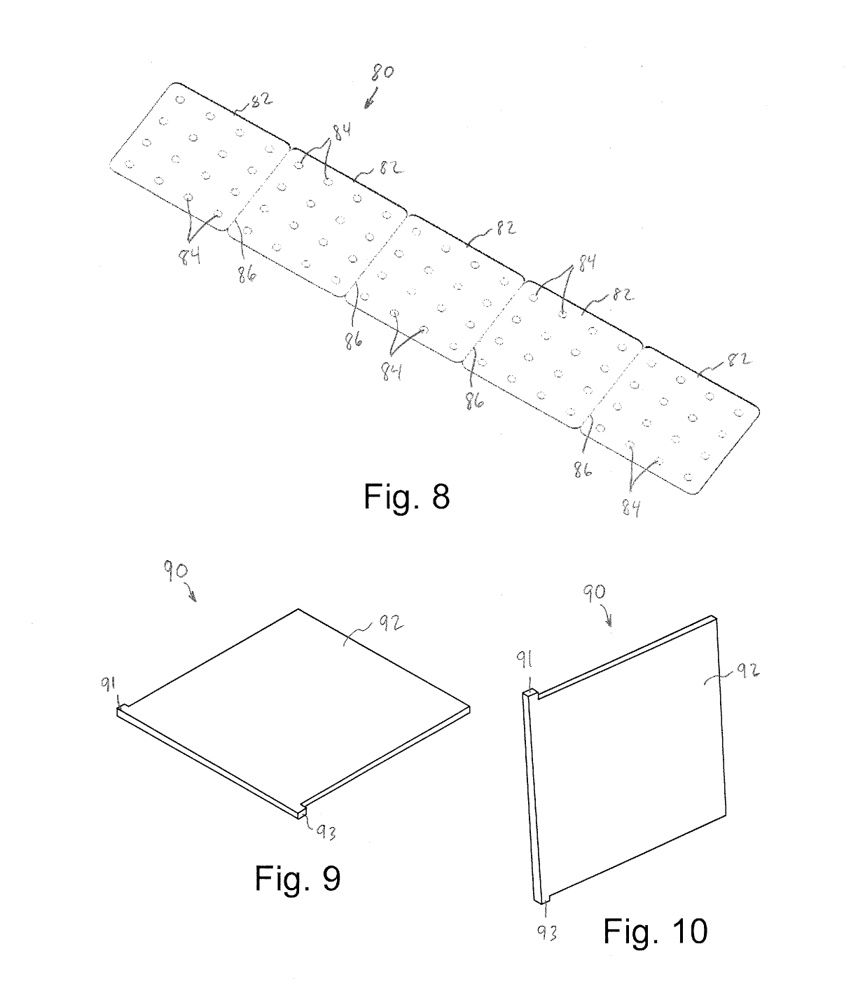

FIG. 8 illustrates an exemplary support mat 80 in accordance with an embodiment of the invention. The illustrated support mat 80 includes a plurality of mat bodies 82 interconnected at splittable joints 86. Each mat body 82 is made from an elastomeric material, for example, rubber, and is configured to support a cube or a portion of a cube 10, 30, 40. The mat bodies 82 may be separated along a respective joint 86 to size the mat 80 as desired. A plurality of nubs 84 extend from one or both surfaces of the mat body 82 and help to minimize sliding between the cubes 10, 30, 40 and the mat 80 and/or between the mat 80 and a surface upon which it is positioned.

Referring to FIGS. 9-16, various divider panels 90, 100, 110 and 120 will be described. The divider panel 90 has a planar body 92 with opposed tabs 91 and 93. The planar body 92 is sized such that the panel 90 may be positioned horizontally (FIG. 9) in the grooves 16 of side walls 13 and 17 of cube 10 or vertically (FIG. 10) in the grooves 16 of side walls 11 and 15 of cube 10 or grooves 16 of side walls 31 and 35 of cube 30. In each position, the tabs 91, 93 are received in respective openings 18 which helps to lock the panel 90 in position.

The divider panel 100 similarly has a planar body 102 with opposed tabs 101 and 103, however, the planar body 102 is sized such that the panel 100 may be positioned horizontally in the grooves 16 of side walls 33 and 37 of cube 30. Again, the tabs 101, 103 are received in respective openings 18 which helps to lock the panel 100 in position.

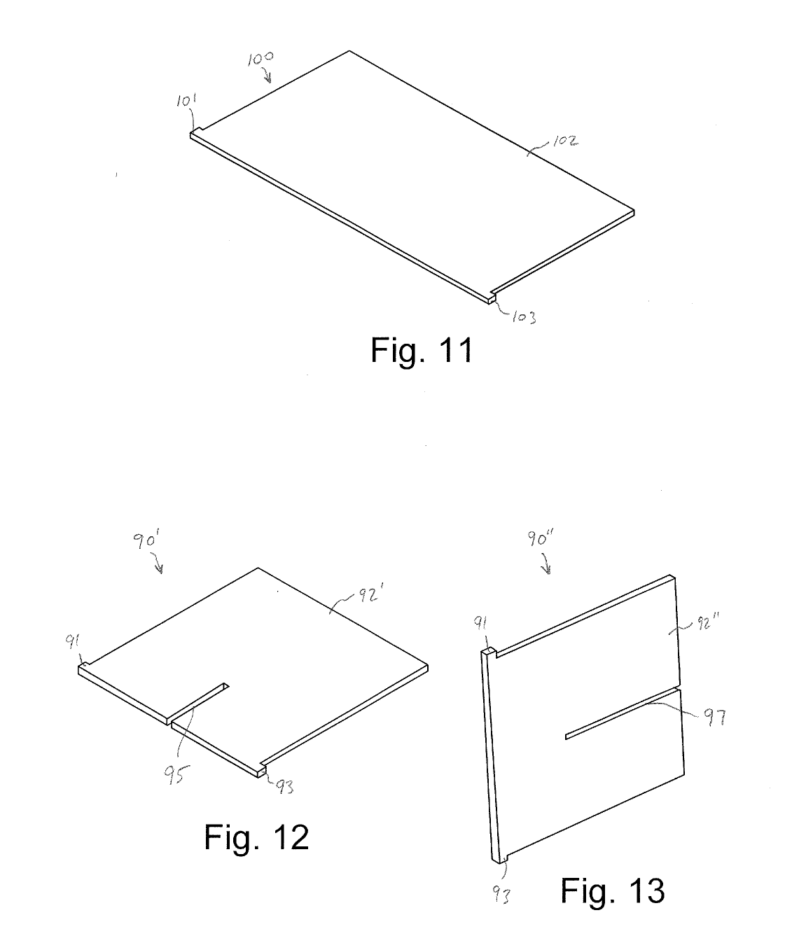

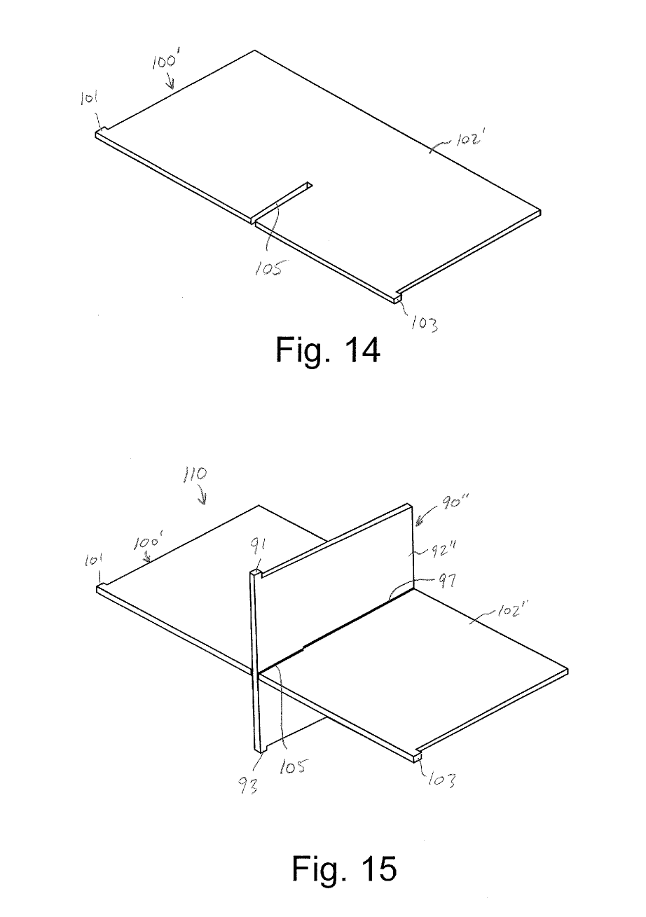

The divider panel 110 illustrated in FIG. 15 is configured to divide the cube 30 both horizontally and vertically. While the divider panel 110 is configured to divide the cube 30, it can also be configured for the cube 10. The divider panel 110 includes a horizontal connector panel 90′, 100′ interconnected with a vertical connector panel 90″. Referring to FIGS. 12 and 14, the horizontal connector panels 90′, 110′ are substantially the same as the divider panels of FIGS. 9 and 11, respectively, except that the body 92′, 102′ has a slot 95 extending thereinto from the front edge. The slot 95 is configured to receive a portion of the vertical connector panel 90″. With reference to FIG. 13, the vertical connector panel 90″ is substantially the same as the divider panel of FIG. 10 except that the body 92″ includes a slot 97 extending thereinto from the rear edge. The slot 97 is configured to receive a portion of the horizontal connector panel 90′, 100′.

The divider panel 110 is positioned within the cube 30 such that the horizontal connector panel 100′ is positioned horizontally in the grooves 16 of side walls 33 and 37 and the vertical connector panel 90″ is positioned in the grooves 16 of the side walls 31 and 35. Again, the tabs 111, 113, 115, 117 are received in respective openings 18 which helps to lock the panel 110 in position.

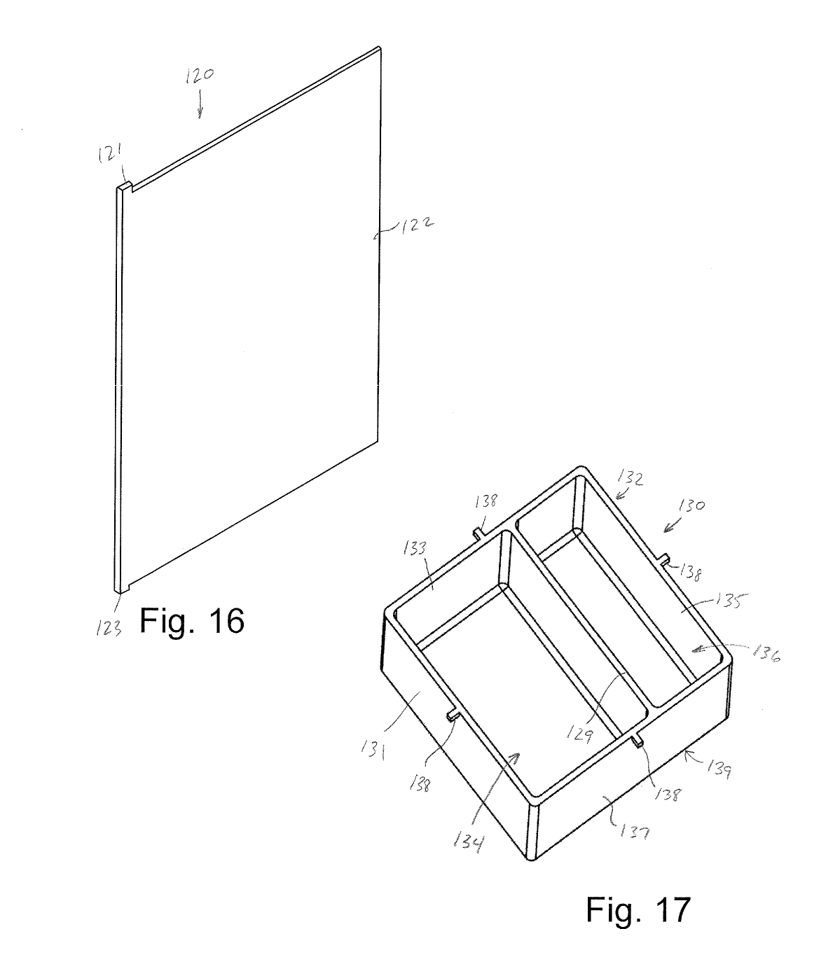

Referring to FIG. 16, the divider panel 120 is configured to divide the cube 40. The divider panel 120 has a planar body 122 with opposed tabs 121 and 123. The planar body 122 is sized such that the panel 120 may be positioned in opposed grooves 16 of side walls 41 and 45 of cube 40. Again, the tabs 121, 123 are received in respective openings 18 which helps to lock the panel 120 in position.

Referring to FIG. 17, an exemplary divider cup 130 will be described. The divider cup 130 has a body 132 defined by a plurality of side walls 131, 133, 135, 137 and a base wall 139. A fixed divider wall 129 extends between the side walls 133 and 137 to define two open internal chambers 134 and 136. It is recognized that additional divider walls may be provided to define additional chambers. The outside surface of each side wall 131, 133, 135, 137 includes an outwardly extending tab 138. The illustrated divider cup 110 is sized to fit within the internal chamber 20 of the cube 10 with each tab 138 received in a respective opening 18. The divider cup 110 is not limited to the illustrated size and configuration and may be configured to fit within the cubes 30, 40.

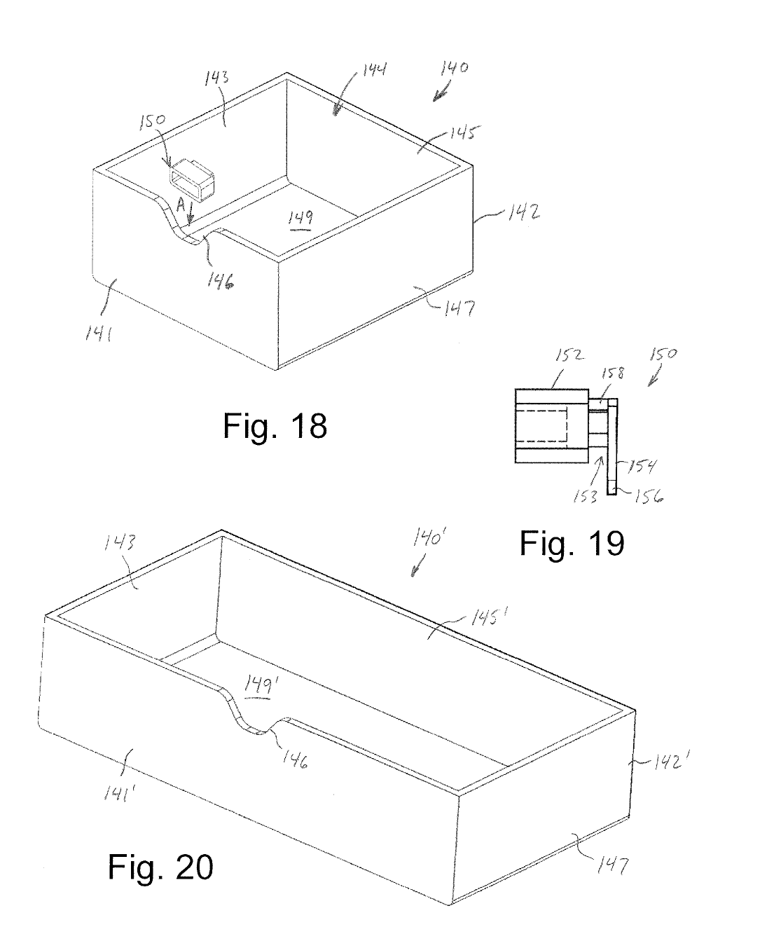

Referring to FIGS. 18-20, drawers 140, 140′ configured to be positioned in the cubes 10, 30, respectively, will be described. With reference to FIG. 18, the drawer 140 has a plurality of side walls 141, 143, 145, 147 extending from a base surface 149 to define an internal chamber 144. In the illustrated embodiment, the side walls 141, 143, 145, 147 and the base surface 149 are sized such that the drawer 140 fits within one half of the chamber 20 of the cube 10. A divider panel 90 may or may not be utilized to divide the cube 10 in half. The drawer 140′ illustrated in FIG. 20 is substantially the same except that the side walls 141′, 146′ and the base surface 149′ are longer such that the drawer 140′ is sized to be received within one half of the chamber 34 of the cube 30. Both drawers 140, 140′ may have other configurations and may be otherwise sized. For example, the side walls 141, 143, 145, 147 may have a height wherein the drawer 140 occupies the entire chamber 20.

One of the side walls 141, 141′ includes a notch 146 which may be utilized to grasp and pull the drawer 140. 140′ out of the cube 10, 30. Alternatively, a handle 150 may be secured within the notch 146 and extend from the side wall 141, 141′ to further accommodate pushing and pulling of the drawer 140, 140′. Referring to FIG. 19, an exemplary handle 150 includes a body 152 with a latch plate 154 spaced from the body 152 by an extension 158. The latch plate 154 extends substantially parallel to the body 152 such that a wall receiving groove 153 is defined between a lower portion 156 of the latch plate 154 and the body 152. The handle 150 is lowered into the notch 156 as indicated by arrow A in FIG. 18 until the side wall 141 is received in the receiving groove 153.

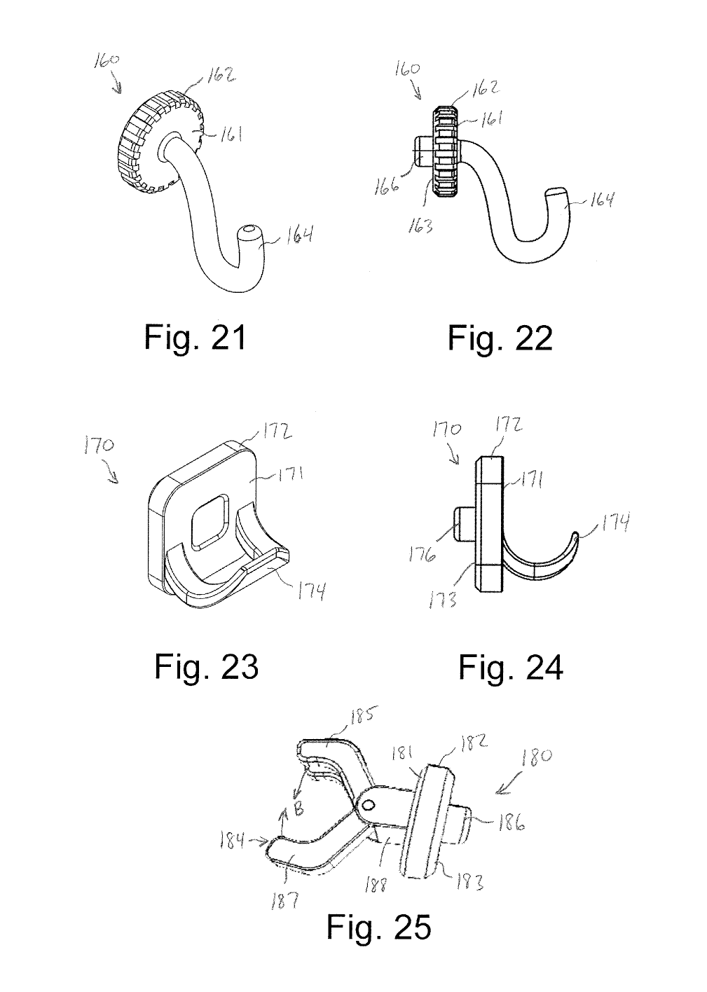

Referring to FIGS. 21-24, two exemplary hooks 160, 170 will be described. Each hook 160, 170 includes a body 162, 172 with opposed surfaces 161, 171 and 163, 173. A curved hook member 164, 174 extends from one surface 161, 171 while a peg 166, 176 extends from the other surface 163, 173. Each peg 166, 176 is sized and configured to be received in one of the peg holes 14 to mount the hook 160, 170 on the inside or outside surface of one of the cubes 10, 30, 40.

FIG. 25 illustrates an exemplary clip 180 in accordance with an embodiment of the invention. The clip 180 includes a body 182 with opposed surfaces 181, 183. A jaw assembly 184 extends from the surface 181 and a peg 186 extends from the opposite surface 183. The peg 186 is sized and configured to be received in one of the peg holes 14 to mount the clip 180 on the inside or outside surface of one of the cubes 10, 30, 40. The jaw assembly 184 includes opposed jaw members 185, 187 pivotally supported by a mount 188 extending from the surface 181. A spring (not shown) within the mount 188 biases the jaw members 185, 187 toward one another as indicated by the arrows B. The clip 180 is configured to hold a pen, a picture or the like between the opposed jaw members 185 and 187.

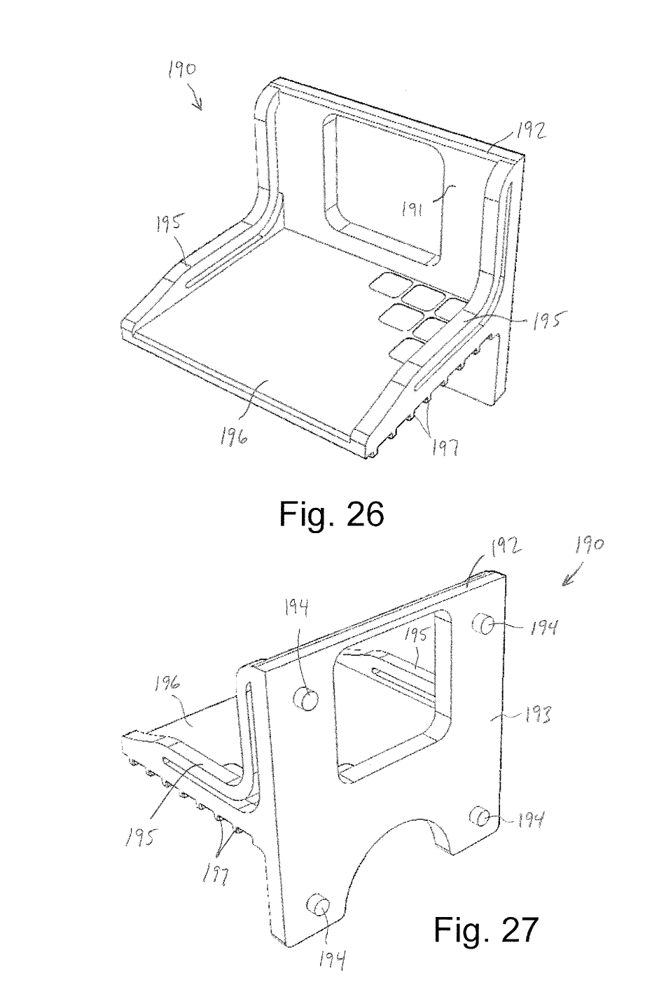

Referring to FIGS. 26-27, an exemplary support shelf 190 in accordance with an embodiment of the invention will be described. The support shelf 190 includes a body 192 with opposed surfaces 191, 193. A pair of support arms 195 extend from the surface 181 and support a shelf surface 196. Ribs 197 or the like may extend under the shelf surface 196 to provide additional support. A plurality of pegs 194 extend from the opposite surface 193 of the body 192. The pegs 194 are sized and configured to be received in respective ones of the peg holes 14 to mount the support shelf 190 on the inside or outside surface of one of the cubes 10, 30, 40.

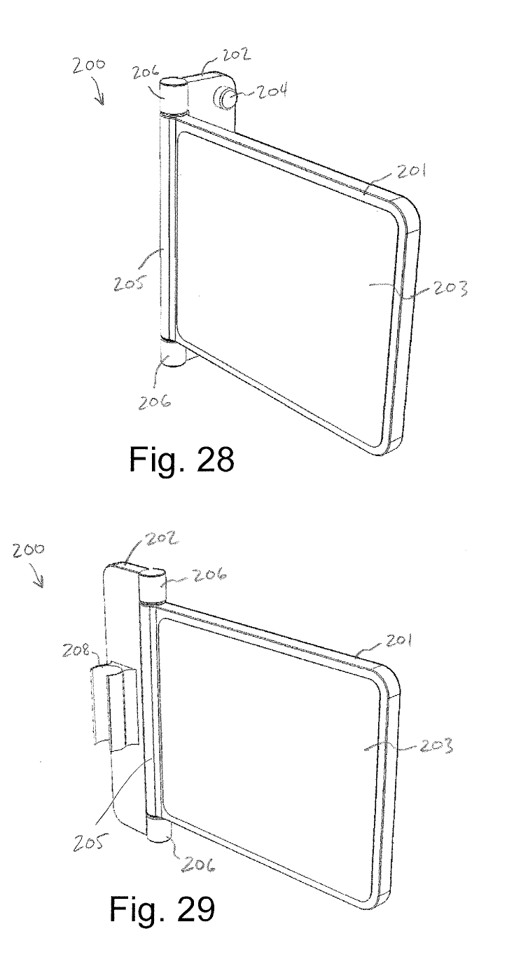

Referring to FIGS. 28-29, an exemplary dry erase assembly 200 in accordance with an embodiment of the invention will be described. The dry erase assembly 200 includes a mounting plate 202 with a pair of pegs 204 extending therefrom. The pegs 204 are sized and configured to be received in respective ones of the peg holes 14 to mount the dry erase assembly 200 on one of the cubes 10, 30, 40. The mounting plate 202 includes a pair of opposed pivot blocks 206 configured to receive a pivot shaft 205 of the board 201 having a dry erase surface 203. The board 201 is pivotal relative to the mounting plate 202 such that the board 201 may be moved from a closed position which closes a portion of the cube (see FIGS. 1 and 28) to an open position (see FIG. 29) wherein the board 201 extends from the cube 10, 30, 40. As seen in FIG. 29, in the illustrated embodiment, the mounting plate 202 includes a clip 208 configured to hold a dry erase marker (see FIG. 1).

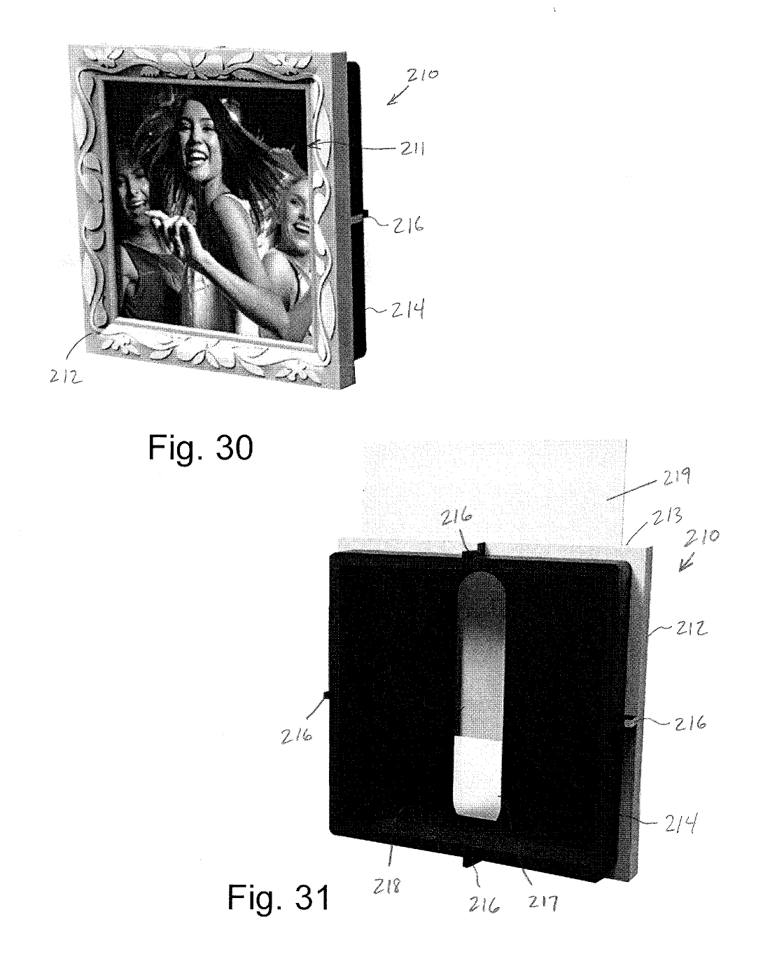

With reference to FIGS. 30-31, an exemplary picture frame 210 in accordance with an embodiment of the invention will be described. The picture frame 210 includes a frame body 212 with a picture opening 211 therethrough. A picture surround 214 extends from the rear surface of the frame body 212 and supports a backerboard 218. A picture receiving area is defined inside of the picture surround 214 and backerboard 218 such that a picture 219 may be slid through a slot 213 in the frame body 212 and into the picture receiving area. An opening 217 in the backerboard 218 facilitates access to a picture 219, for example, to push the picture out of the slot 213 to remove the picture from the frame 210. A plurality of tabs 216 extend between the frame body 212 and the picture surround 214. In the illustrated embodiment, the frame body 212, the picture surround 214 and the tabs 216 are configured such that the picture surround 214 is received in the chamber 20 of a cube 10 while the tabs 216 are received in respective openings 218 while the frame body 212 overlies the side walls 11-17. The picture frame 210 may be sized and configured such that it fits within the other cubes 30, 40.

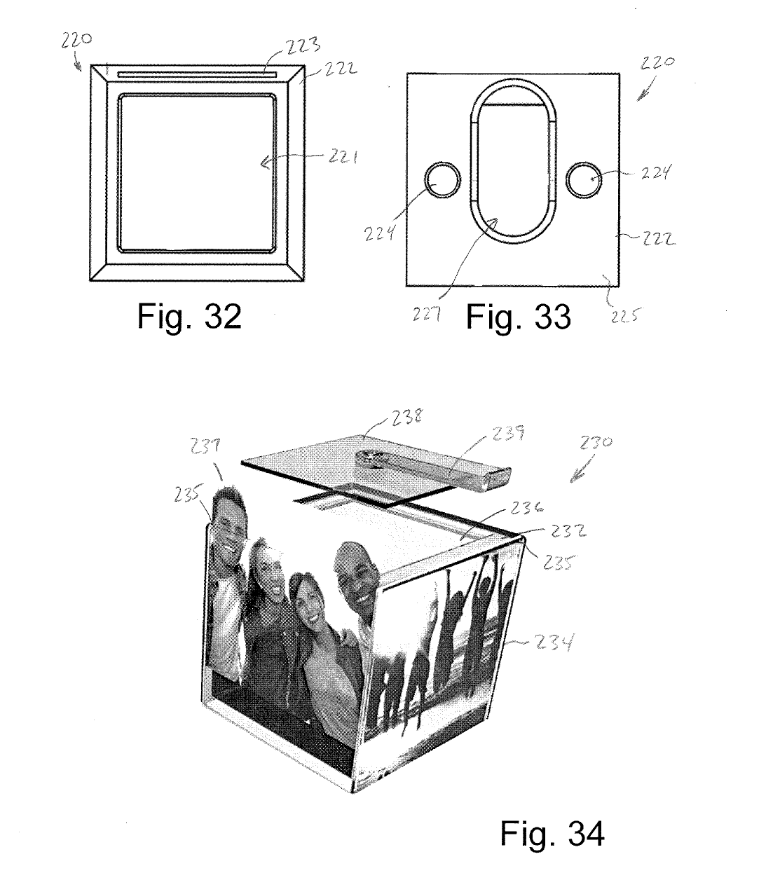

Referring to FIGS. 32-33, an exemplary mini picture frame 220 in accordance with an embodiment of the invention will be described. The mini picture frame 220 includes a frame body 222 which defines a picture opening 221 and a picture receiving slot 223. An opening 227 in the rear surface 225 of the body 222 facilitates removal of the picture by sliding it out of the slot 223. A pair of pegs 224 extend from the rear surface 225. The pegs 224 are sized and configured to be received in respective ones of the peg holes 14 to mount the picture frame 220 on the inside or outside surface of one of the cubes 10, 30, 40.

FIG. 34 illustrates an exemplary picture cube 230 in accordance with an embodiment of the invention. The picture cube 230 includes an inner cube body 232 surrounded by an outer cube body 234 such that a space 235 is defined between each side wall of the inner cube body 232 and the respective side wall of the outer cube body 234. A picture 237 may be slid into one or more of the spaces 235. Additionally, a picture receiving recess 236 may be defined in the exposed surface of the inner cube body 232. A transparent cover 238 is configured to retain a picture or the like within the picture receiving recess 236. The outer cube body 234 is sized such that the picture cube 230 is positionable within the chamber of one of the cubes 10, 30, 40. In the illustrated embodiment, a handle 239 extends from the cover 238 to facilitate removal of the picture cube 230 from one of the cubes 10, 30, 40.

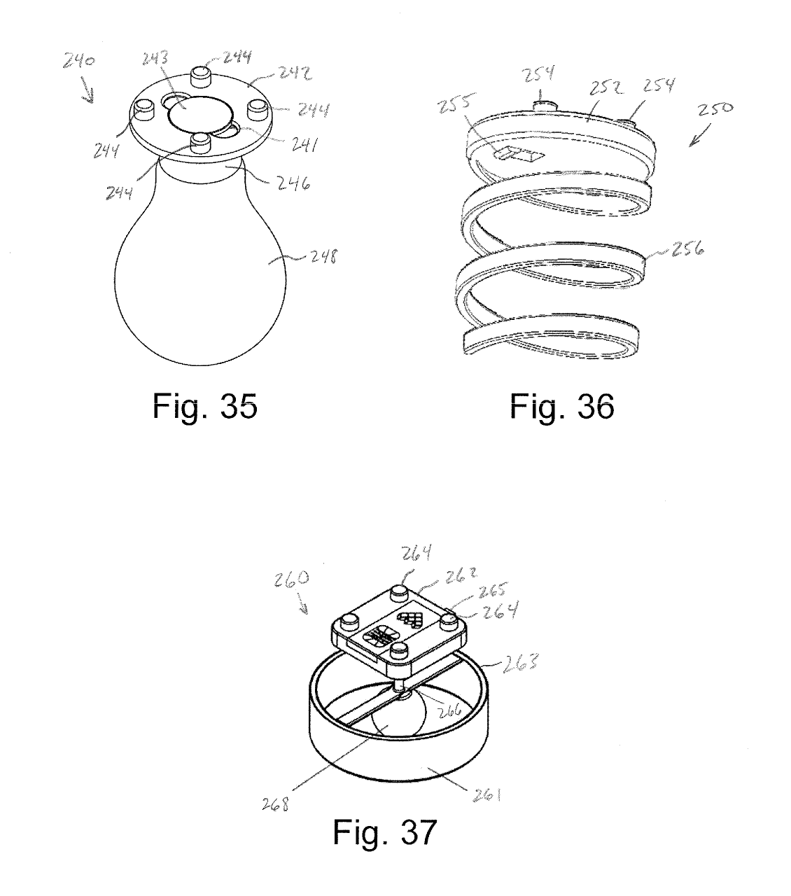

Referring to FIGS. 35-39, various exemplary light fixtures will be described. FIG. 35 illustrates a bulb light fixture 240. The bulb light fixture 240 includes a body 242 with a plurality of pegs 244 extending from a surface thereof. The pegs 194 are sized and configured to be received in respective ones of the peg holes 14 to mount the support shelf 190 on the inside or outside surface of one of the cubes 10, 30, 40. The body 242 houses a battery compartment 241 with a removable cover 243 to secure a battery (not shown) therein. A socket 246 extends from the opposite surface of the body 242 and is configured to threadably receive a bulb 248, which may be of various sizes. An on/off switch (not shown) is also provided on the body 242 and is configured to facilitate turning the power from the battery to the bulb 248 on and off.

FIG. 36 illustrates an exemplary ornamental light fixture 250 which similarly includes a body 252 which houses a battery or the like and includes a plurality of pegs 254 configured to be received in respective ones of the peg holes 14 to mount the light fixture 250 on the inside or outside surface of one of the cubes 10, 30, 40. A light coil 256 extends from the opposite surface of the body 252 and is configured to emit LED light or the like. An on/off switch 255 is also provided on the body 252 and is configured to facilitate turning the power from the battery to the optical coil 256 on and off.

FIG. 37 illustrates another exemplary ornamental light fixture 260 which includes a body 262 which houses a battery or the like and includes a plurality of pegs 264 configured to be received in respective ones of the peg holes 14 to mount the light fixture 260 on the inside or outside surface of one of the cubes 10, 30, 40. A shaft 266 extends from the opposite surface of the body 262 and supports a frame 263 and a bulb 268. A decorative shade 261 is detachably secured to the frame 263 to provide a desired ornamental appearance. While the frame and shade are shown as circular, they can have other configurations, for example, square, rectangular, triangular, oval or the like. An on/off switch 265 is also provided on the body 262 and is configured to facilitate turning the power from the battery to the bulb on and off.

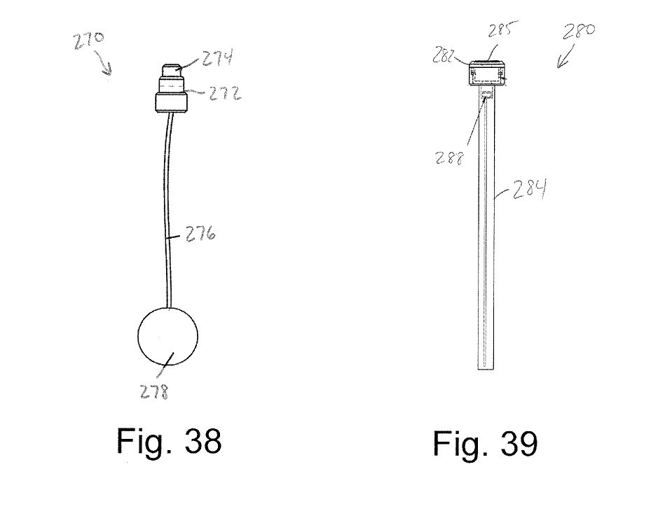

FIG. 38 illustrates an exemplary single peg light fixture 270 in accordance with an embodiment of the invention. The single peg light fixture 270 includes a body 272 which houses a battery or the like and includes a peg 274 configured to be received in one of the peg holes 14 to mount the light fixture 270 on the inside or outside surface of one of the cubes 10, 30, 40. A cord 276 extends from the opposite surface of the body 272 and supports an LED bulb 278 or the like. The cord 276 may be configured such that pulling on the cord 276 facilitates turning the power from the battery to the bulb on and off.

FIG. 39 illustrates another exemplary single peg light fixture 280 in accordance with an embodiment of the invention. The single peg light fixture 280 includes a body 282 which houses a battery or the like. An extended, translucent body 284 extends from the body 282. The extended body 284 is configured to extend through one of the peg holes 14 to mount the light fixture 280 on one of the cubes 10, 30, 40. A mini LED bulb 288 or the like is positioned within the extended body 284 and is powered by the battery. An on/off button 285 on the body 282 controls actuation of the bulb 288. Upon actuation, the light from the bulb 288 shines along and out of the extended body 284.

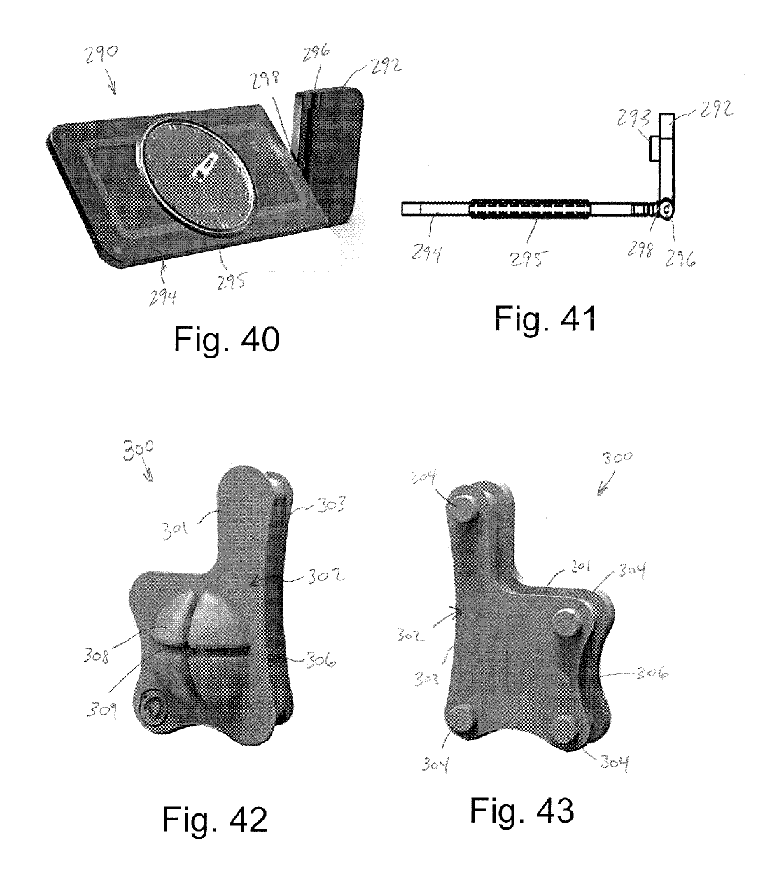

Referring to FIGS. 40-41, an exemplary clock accessory 290 will be described. The clock accessory 290 includes a body 292 with one or more pegs 293 extending therefrom and configured to be received in respective ones of the peg holes 14 to mount the clock accessory 290 on one of the cubes 10, 30, 40. A secondary body 294 is pivotally connected to the body 292 via first and second pivot connections 296, 298 which facilitate pivoting of the secondary body 294 around two axes relative to the body 292. It is contemplated that only one pivot connection may be provided or the secondary body 294 may alternatively be fixed relative to the body 292. A clock 295 is supported on the secondary body 294. While an analog clock 295 is illustrated, other clocks, for example, a digital clock, may be utilized.

Referring to FIGS. 42-43, an exemplary ear bud support assembly 300 will be described. The ear bud support assembly 300 includes a body 302 with a front surface 301 and a rear surface 303 with a channel 306 defined therebetween. The channel 306 is sized such that the ear bud cord (not shown) may be wrapped thereabout. The rear surface 303 includes a plurality of pegs 304 extending therefrom and configured to be received in respective ones of the peg holes 14 to mount the ear bud support assembly 300 on one of the cubes 10, 30, 40. The front surface 301 may define a protrusion 308 with slots 309 configured to receive the ends of the cord or the like.

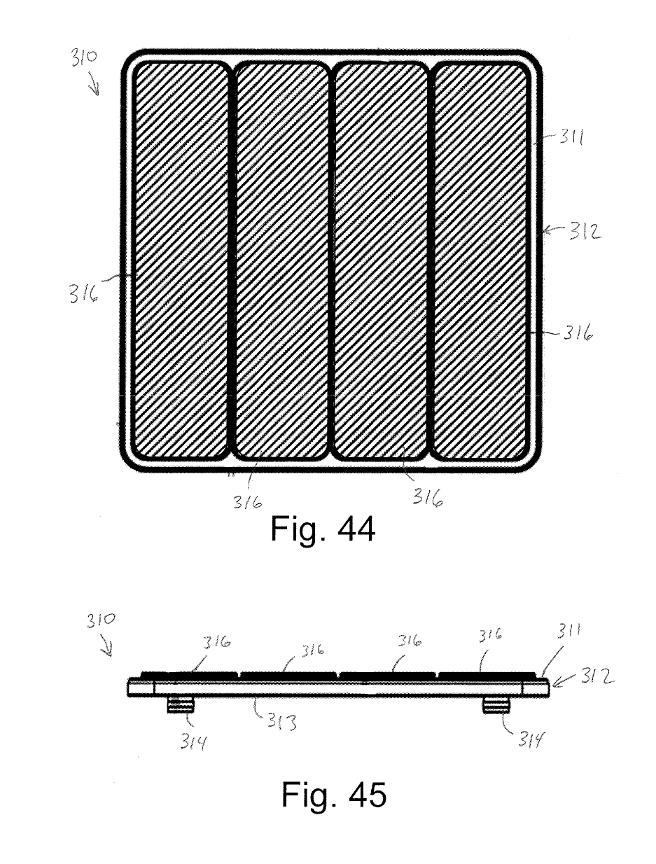

Referring to FIGS. 44-45, an exemplary support pad 310 will be described. The support pad 310 includes a body 312 with a front surface 311 and a rear surface 313. A plurality of elastomeric pads 316 extend along the front surface 311 and are configured to provide cushioned support for a phone or the like positioned on the support pad 310. The rear surface 313 includes a plurality of pegs 314 extending therefrom and configured to be received in respective ones of the peg holes 14 to mount the support pad 310 on one of the cubes 10, 30, 40.

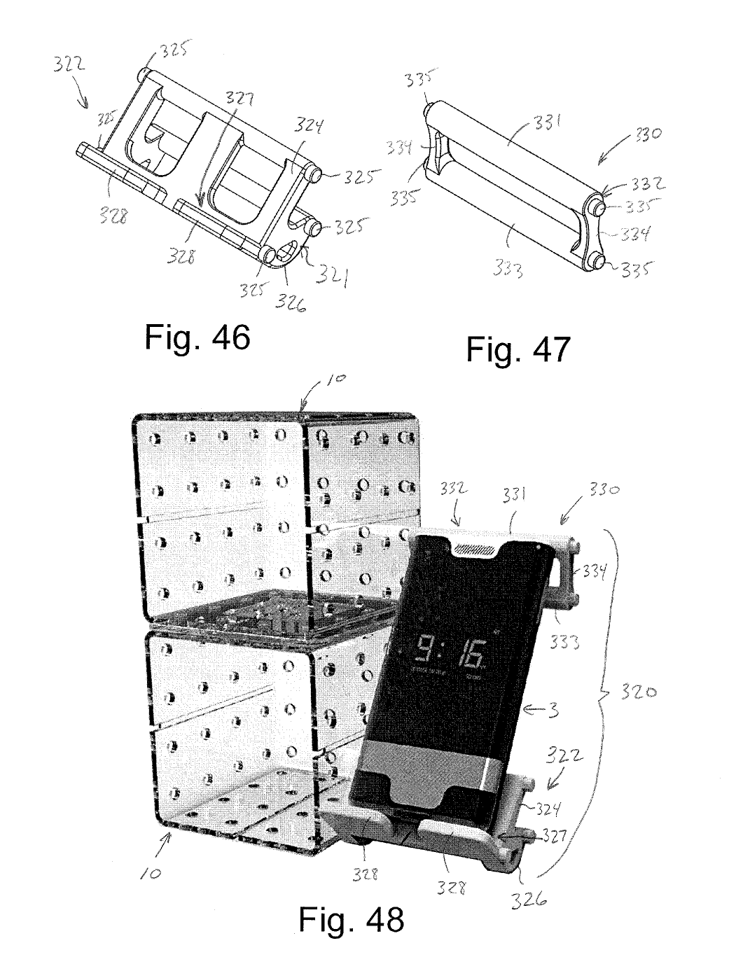

Referring to FIGS. 46-48, an exemplary phone mount assembly 320 will be described. The phone mount assembly 320 includes a base member 322 and an upper support 330. The base member 322 includes a body 321 with a support surface 324 supported at an angle by a base 326. A pair of support tabs 328 extend from the support surface 324 to define a receiving area 327 for a base of the phone 3. A plurality of pegs 325 extend from each side of the body 321 and are configured to be received in respective ones of the peg holes 14 to mount the base member 322 on one of the cubes 10, 30, 40. The upper support 330 includes a body 332 defined by a pair of support bars 331 and 333 interconnected by end bars 334. Pegs 335 extend from each side of the body 332 and are configured to be received in respective ones of the peg holes 14 to mount the upper support 330 on one of the cubes 10, 30, 40 in spaced relation relative to the base member 332 such that the upper support 330 supports an upper portion of the phone 3.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

What is claimed is:

1. A modular storage system comprising:
at least one storage cube having a body defined by a plurality of side walls and a base wall about an internal chamber, at least one of the side walls or the base wall including a plurality of peg holes extending through the respective wall in a given pattern; and
at least one connector plate having a planar body with opposed first and second surfaces, at least the first surface having a plurality of pegs extending therefrom in a pattern complementary to the given pattern such that the at least one connector plate is connected to the at least one storage cube by positioning at least a subset of the plurality of pegs extending from the first surface into respective peg holes on the at least one storage cube.

2. The modular storage system according to claim 1 wherein the at least one connector plate has a plurality of a plurality of pegs extending from the second surface in a pattern complementary to the given pattern such that the at least one connector plate is connected to a second of the at least one storage cubes by positioning at least a subset of the plurality of pegs extending from the second surface into respective peg holes on the second of the at least one storage cube.

3. The modular storage system according to claim 1 wherein the second surface of the at least one connector plate is substantially flat and a plurality of magnets are embedded in the planar body adjacent the second surface.

4. The modular storage system according to claim 1 wherein the second surface of the at least one connector plate is substantially flat and a plurality of magnets are embedded in at least a subset of the plurality of pegs extending from the first surface.

5. The modular storage system according to claim 1 wherein the at least one storage cube includes at least two opposed grooves extending along respective inside surfaces of opposed side walls and wherein the two opposed grooves are configured to receive and retain a divider panel which divides the internal chamber into at least two sub-chambers.

6. The modular storage system according to claim 5 wherein the divider panel has opposed tabs extending from an end thereof, the tabs configured to be received in corresponding openings adjacent the grooves in the respective side walls of the at least one storage cube.

7. The modular storage system according to claim 1 wherein the plurality of peg holes extend through each of the side walls and the base wall.

8. The modular storage system according to claim 1 wherein the given pattern is a grid pattern with each of the peg holes positioned equally distant from adjacent peg holes.

9. The modular storage system according to claim 1 wherein the at least one storage cube has a square configuration.

10. The modular storage system according to claim 1 wherein the at least one storage cube has a rectangular configuration.

11. The modular storage system according to claim 10 wherein at least one of the side walls has a notch defined therein.

12. The modular storage system according to claim 1 further comprising a drawer configured to be slidably positioned within the internal chamber of the at least one storage cube.

13. The modular storage system according to claim 12 wherein a removable handle is secured to the drawer.

14. The modular storage system according to claim 1 further comprising a divider cup including a cup body including a plurality of side walls and a base wall about a cup internal chamber wherein a dividing wall extends between at least two of the cup side walls and divides the cup internal chamber into at least two cup sub-chambers and wherein the cup body is configured to be received within the internal chamber of the at least one storage cubes.

15. The storage assembly according to claim 14 wherein at least a subset of the cup side walls have outwardly extending tabs configured to be received in corresponding openings in respective side walls of the at least one storage cube.

16. The modular storage system according to claim 1 further comprising an accessory including a body with at least one peg extending therefrom and configured to be received and retained in one of the peg holes.

17. The modular storage system according to claim 16 wherein the accessory is selected from the group consisting of a hook, a clip, a support shelf, a dry erase assembly, a mini picture frame, a light fixture, a clock accessory, an ear bud support, a support pad and a phone mount assembly.
